(19) United States
(12) Patent Application Publication
(10) Pub. No.: US 2023/0281709 A1
(43) Pub. Date: Sep. 7, 2023

(54) CORPORATE CREDIT RATINGS BASED ON THE OVERALL ORGANISATIONAL PERFORMANCE

(71) Applicants: VISHVESH RAJENDRAKUMAR PATHAK, BANBURY (GB); PHILIP RICHARD WALSH, ONTARIO (CA); KERRY THOMAS SULLIVAN, LONDON (GB)

(72) Inventors: VISHVESH RAJENDRAKUMAR PATHAK, BANBURY (GB); PHILIP RICHARD WALSH, ONTARIO (CA); KERRY THOMAS SULLIVAN, LONDON (GB)

(73) Assignees: VISHVESH RAJENDRAKUMAR PATHAK, BANBURY (GB); PHILIP RICHARD WALSH, ONTARIO (CA); KERRY THOMAS SULLIVAN, LONDON (GB)

(21) Appl. No.: 18/197,124

(22) Filed: May 15, 2023

Related U.S. Application Data
(63) Continuation-in-part of application No. 16/194,110, filed on Nov. 16, 2018.

(51) Int. Cl. G06Q 40/03; G06Q 10/0637

(52) U.S. Cl. CPC G06Q 40/03; G06Q 10/0637

(57) ABSTRACT

A corporate credit ratings methodology based on the measurement of overall organisational performance is defined and explained. The overall organisational performance is then further explained that it can be derived by measuring over-arching variables of stability, resilience and sustainability. The overall organisational performance corresponds to existing ratings scale which shows corporate credit ratings can be given from the derived overall organisational performance for each company. The values of sub-dimensions can be collected and benchmarked from public and private data sources as explained in the embodiments. A collected data points can be benchmarked, weighted and finally values of stability, resilience and sustainability can be generated leading to the overall organisational performance score and its further interpretation into assigning a corresponding credit ratings to a corporate.

### BACKGROUND OF THE INVENTION

This invention of corporate credit ratings on the basis of overall organisational performance pertains to two domains strategic management and corporate finance and their multiple sub-sections such as organisational performance or credit ratings.

The current practice of rating agencies providing credit ratings is largely based on the measurement of financial performance, liquidity and risks of the company. The long term survival of companies receiving these ratings and measures which reveal the true state of the company such as overall organisational performance, strategic capabilities or social responsibilities are overlooked by ratings agencies. The large population of retail investors (individuals) and institutional investors (hedge funds, pension funds, mutual funds or insurance companies) depend upon such ratings in their process of making investment decisions. Furthermore, individual investors have no incentive to conduct research on strategy, operations, performance, systems and management of companies in detail as the cost of such research could be more than the return on investments. Issuer companies jumble up their data to obtain the desired credit ratings and their management aims to maintain stock prices to retain investors. In addition to this, information dissemination by market intermediaries such as trading analysts, stock brokers or industry sector indices do not reflect a set of right measures of risk or performance with in them. This scenario leaves credit rating agencies, issuers, investors, regulators and other market participants without any facts about ‘what is happening with credit ratings of companies’.

Credit rating agencies (CRAs) create market information for investors about companies by releasing long term and short term ratings, upgrades or downgrades about the risk associated with bond or debt quality. This information leads to the movement of an individual company's stock price and in some cases it affects the movement of an entire index such as the Dow Jones Industrial Average (DJIA or US30), FTSE100 (UK100) or BSE SENSEX.

Even though the rating agencies follow these companies for a long time, their current practices primarily focus on financial performance or monetary risk with short term views which results in the inaccurate and unscrupulous credit ratings. Another example of such flawed output is Enron, just four days before Enron was declared bankrupt, its debt was still rated an ‘investment grade’ by the major credit rating agencies.

Many governments around the world have created reform acts to address issues of reporting, issuer payments or further regulation for existing credit ratings agencies however these are limited to solve administrative issues rather than conceptual flaws and disagreements about ‘what to measure’ and ‘how to measure’ so that ratings derived and issued could represent the true state of companies. This invention of ‘corporate credit ratings based on the overall organisational performance’ solves a set of conceptual flaws in the current ratings methodologies such as an over-emphasis on the financial performance, absence of strategic views on multiple organisational dimensions and all involved stakeholders.

### SUMMARY OF INVENTION

As mentioned in the embodiment, an organisational performance based corporate credit ratings system includes a performance module identifying stable, resilient and sustainable companies and determine the benchmarking factors from data collected. The benchmarking factors corresponds with sub-dimensions of stability, resilience and sustainability. A data collection module collects data for all sub-dimensions for a company. A benchmarking module then determines the values for all sub-dimensions from the data collected and estimated performance for a company is calculated based on a scale of 1 to 10. Based on the one or more components of overall organisational performance then credit ratings module generates a corporate credit rating for a whole company. One or more the modules as shown in the FIG. 1 contains hardware system executing machine readable instructions.

Report generating module produces credit ratings report for the company which is based on the estimated overall organisational performance. This overcomes a set of conceptual flaws in the current credit ratings methodologies as adopted by major rating agencies since this invention utilises the overall organisational performance as a main basis to generate corporate credit ratings. This new overall organisational performance based rating for the whole company would be more accurate, precise and neutral as compared to an existing system of measuring only financial components in terms of credit risk by way of probability of default (PD) or loss given the default (LGD).

The idea is not to look at ‘the empty part’ or ‘what is not occurring’ but to measure ‘the achieved part’ and ‘what is actually going on inside, outside and at the micro and macro interfaces with the company’. To that effect, this invention details ‘which variables should be measured’ and ‘how to measure them’ so as to derive the overall organisational performance and then corresponding final corporate rating for each company within their industry sample. Three overarching indices proposed in this invention which represent the overall organisational performance to derive a corporate credit rating are: Stability (T), Resilience (R) and Sustainability (S) of an organisation as shown in the FIG. 2.

This innovation proposes an overall organisational performance as a main basis to generate credit rating of a company. Organisational performance is a currency common to companies where companies can be easily compared. This invention considers organisational performance a three dimensional higher order construct of stability, resilience and sustainability. This invention enables corporates to analyse their management and take appropriate actions where necessary to improve their detailed performance straightforwardly. This invention conveys the credit worthiness of the whole company and it actually analyses a true state of the company as reflected in their credit rating. This invention utilises multiple stakeholders' view and measures stakeholders' satisfaction in each of its over-arching dimension of overall organisational performance. This invention includes all possible organisational performance measures beyond the existing system of credit ratings which measures just financial performance, risk or liquidity.

### BRIEF DESCRIPTION OF THE SEVERAL VIEWS OF THE DRAWING(S)

This invention and its embodiments are described in detail in the following description with regard to the following figures.

FIG. 1 illustrates a system of organisational performance based credit ratings system according to embodiments in this invention;

FIG. 2 explains the crucial linkages between organisational performance and credit rating and sub-dimensions of overall organisational performance according to embodiments;

FIG. 3 shows stability dimensions according to embodiments;

FIG. 4 illustrates resilience dimensions according to embodiments;

FIG. 5 illustrates sustainability dimensions according to embodiments

FIG. 6 illustrates activity flowchart of a method to determine the factors and how to generate a final credit rating applying score of overall organisational performance derived from stability, resilience and sustainability according to embodiments.

TABLE 1 provides how Stability (T) can be measured using sub-dimensions and their indicators and actual measures of these indicators.

TABLE 2 provides how Resilience (R) can be measured using sub-dimensions and their indicators and actual measures of these indicators.

TABLE 3 provides how Sustainability (S) can be measured using sub-dimensions and their indicators and actual measures of these indicators.

TABLE 4 provides more measures about how Sustainability (S) can be measured using sub-dimensions and their indicators and actual measures of these indicators.

TABLE 5 shows a qualitative assessment score method with 1 to 10 scale.

TABLE 6 shows overall organisational performance scale and its 1 to 10 score interpretation along with how it corresponds to prevalent rating industry symbolic scale.

### DETAILED DESCRIPTION OF THE INVENTION

Overview of the problem and the solution: There are conceptual and administrative flaws in an existing credit ratings system. The first issue to be addressed is the conceptual flaw which could be solved by improving the existing credit ratings methodology for its purpose, approach, orientation and dimensions of measurement. The solution propose for this improvement is to derive ratings on the basis of overall organisational performance. There is no common agreement between researchers and managers for overall organisational performance measurement which leads to the second issue to be addressed: how to measure such comprehensive overall organisational performance for a company so that company could be rated based on such measurement. In the process of addressing these two issues, this invention and its components propose a new concept of corporate credit ratings based on the overall organisational performance which ultimately is measured by over-arching variables of Stability, Resilience and Sustainability.

This invention applies basic fundamental attributes strategic management which states that strategy drives the organisation towards performance; managers must concentrate satisfying multiple stakeholders and not just investors; long term survival is very important; and efficiency and effectiveness are equally important. Based on these four key attributes, it is proposed to measure organisational performance which would include overall measurement, measurement of satisfaction of each stakeholder group, both short-term and long-term measures for example, profitability or sustainability embedded in derivation and concentrating on both efficiencies and effectiveness.

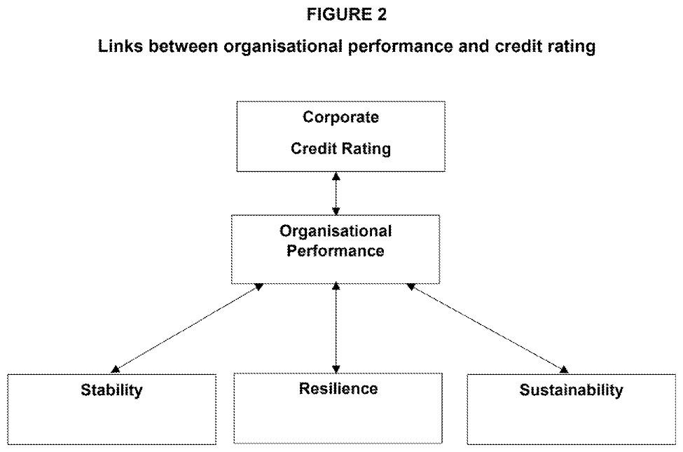

A strategic decision making can lead to three possible outcomes of certainty, risk or uncertainty. Existing methods concentrate on risk whereas performance based approach of this invention signifies certainty and uncertainty components as well by measuring overall organisational performance. Additionally, financial and operational performance as normally targeted by managers strengthen an internal dimension of stability only. Therefore, one must assess and measure the robustness at the interface of external and internal dimensions that is resilience; and longevity of company's survival and success that is sustainability. This leads one to propose three over-arching and major variables of stability, resilience and sustainability as detailed components of overall organisational performance as mentioned in FIG. 2.

This invention makes an attempt to include all stakeholders in it analyses which requires a proactive strategy beyond existing concepts. There is a strong link between socially responsible behaviour and creation of competitive advantage. Such corporate behaviour of social responsibility, ethics, compliance or innovation could be expected from companies at different life cycle stages responding market dynamics with different type of strategies implemented by managers. Usually managers' initial idea of such behaviour enhances the long term position of a company including its reputation. Therefore, it is required to measure other dimensions which reveal strategic focus of company, stakeholders' satisfaction, its social or environmental performance, compliance and reputation. Such performance measures are included in the indices of resilience and sustainability. Therefore, it is vital to measure an overall organisational performance wherein each dimension analyses how company is performing and maximising value for each of its stakeholders.

The main problem in current methods of credit ratings is a conceptually flawed methodology leading to major problems of how agencies should rate these companies and what should be measured and why. This invention proposes solution to this problem in FIG. 2 in terms of deriving corporate credit ratings based on the overall organisational performance. It further divides measurement of overall organisational performance in terms of stability, resilience and sustainability.

In the following detailed description, many specific details are explained to describe embodiments as much thoroughly as possible. However these embodiments or concepts can be applied or practiced without limitation of the skills or details provided. In some instances, there is explanation of proven details and methods to make it simpler and easy to understand whereas in some sections, known methods have not been detailed so as not to create any confusion within the embodiments. As one can see from the indices different concepts and embodiments can be either utilised together or in separate combinations.

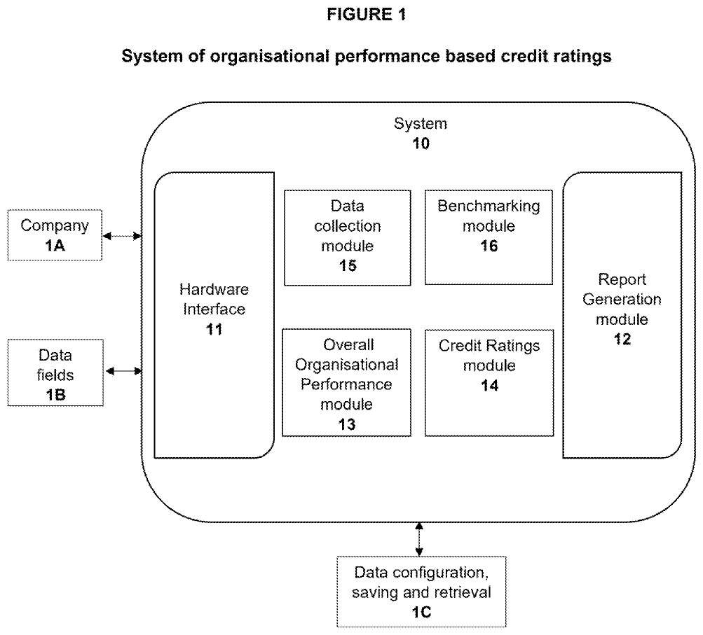

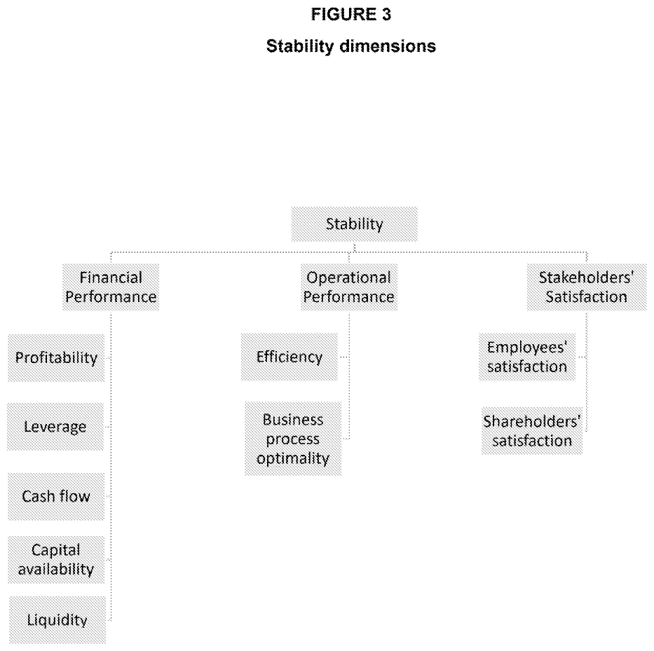

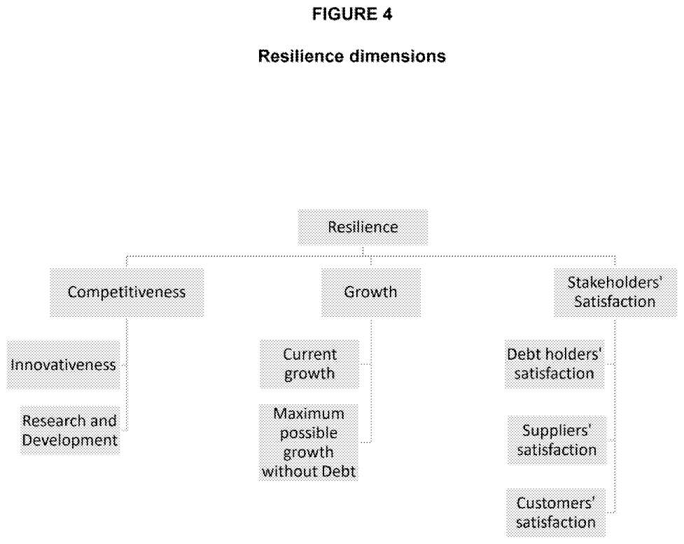

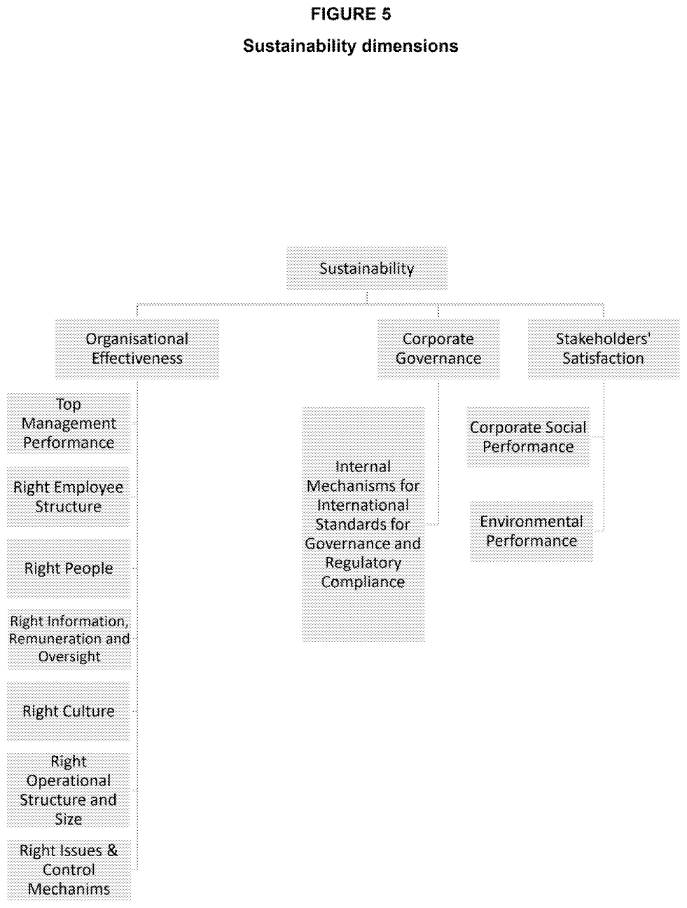

System: A corporate credit ratings systems based on the organisational performance according to an embodiment of this invention, explains, identifies, signifies, determines, analyse and reports the factors from stability, resilience and sustainability leading to overall organisational performance. Stability, Resilience and Sustainability as mentioned in the FIG. 3, FIG. 4 and FIG. 5 includes its sub-dimensions determining the core performance attributes of a company in terms of internal strength, strength against external forces and longevity of the business. Therefore systems applies these variables within the overall organisational performance module to finalise factors leading to ratings module as shown in the FIG. 1. Additionally, this system provides a solution not only to the credit ratings but also to the measurement of overall organisational performance measurement which has no common consensus either among researchers or practicing managers. Well before generating a credit rating report module generates a report, one can analyse performance components through values of stability, resilience and sustainability. This solution encompasses a functionality which would allow one to analyse different sub-dimensions of organisational performance within each variable.

FIG. 1 explains in detail a corporate credit ratings system 10 according to embodiments in this invention. The corporate credit ratings system 10 in FIG. 1 includes hardware interface 11, report generation module 12, overall organisational performance module 13, credit ratings module 14, data collection module 15 and benchmarking module 16. The components of the system 10 may include machine readable instructions or hardware interface 11 or combinations of both. A data storage and retrieval module 1C includes a system that stores data and enables an easy retrieval of stored data. The company 1A is any publicly traded or stock exchange listed profit making company with aim of maximising performance in terms of value addition, growth, profit, longevity of the business and all stakeholders' interests. Data fields 1B are the data collected at any cross section of time for any company in 1A so as to identify values of each sub-dimension leading to benchmarking module 16 once data is collected by module 15. The data fields 1B may source any public or private data about company 1A. The company 1A and data fields 1B are connected to the storage and retrieval module 1C and the system 10 through seamless network interface.

In the FIG. 1 the hardware interface 11 could be a graphical user interface which would enable any user to input data, or to send or receive information from the other modules or components of the system. The benchmarking module 16 analyses values of collected by data collection module 15 for each sub-dimension within the indices. This is further processed by overall organisational module 13 before being sent to credit ratings module 14. Report generation module 12 reports indices values, benchmarking values, performance values and finally credit ratings assigned to the company. Information is stored and retrieved at regular intervals within the data storage and retrieval module 1C. The system comprising all modules and components as shown in the FIG. 1 could work for any number of entities repeatedly and without any constraint and generate overall organisational performance and corresponding credit ratings for any company.

Stability (T): Stability is defined here as ‘strength of an organisation on its own’ which would be a basic requirement for any profit making company. This conceptual perspective makes ‘stability’—an internal dimension wherein major requirements are optimum operational and financial strengths to run the business successfully without external support of government or partnering companies. Stability has been widely regarded as an internal dimension, whether it is a case of stability of banks or stability as an internal control in explaining the organisational effectiveness or stability for the internal environment of the firm formed by its finances, operations or basic organisation design. Therefore, stability as an internal dimension comprises to achieve performance in terms of finance, operations and internal stakeholders satisfaction that is employees and shareholders. Only these two stakeholders: employees and shareholders are considered internal as without them there is no starting point of business to produce any goods or to provide any services. Secondly, employees and shareholders have believed in the company making any profit in the basic organisation design as their wages and return on investments depend upon the company's survival, growth and further success. The other stakeholders comprising customers, suppliers and debt holders which are more influenced by market conditions and competitors and can easily switch to competitors that is why it is considered as external and is not included in analysing and measuring the stability.

Proposing stability as one of the main dimensions of overall organisational performance, employees and shareholders are considered as internal stakeholders and their satisfaction is considered as a basic objective as well as profit and costs for companies. Therefore, it is proposed to apply financial performance, operational performance and internal stakeholders' (employees and shareholders) satisfaction as sub-dimension of stability.

FIG. 3 operationalises three sub-dimensions of stability which is comprised of financial performance, operational performance and stakeholders' satisfaction.

Resilience (R): Resilience is considered as robustness of the organisation to stay successful and growing under the conditions of enormous stress and changes from micro industry forces of competition and macro global forces such as political, economic, social, technological, legal and environmental (PESTLE) forces. However, there are two contrasting views of ‘internal organisation’ perspective focussing on leadership and decision making and ‘external forces’ perspective focussing on industry and economic variables. The internal view is also supported research on resources dynamic capabilities, complex contingencies. The external view which asks managers to deal with complexity, change, uncertain market dynamics and a competitive environment signifies that firms should be robust, efficient and able to turnaround during market turbulence. The solution to this two-fold problem is optimum resilience wherein organisations continue to learn, to adapt, be flexible, lean and agile concurrently. This does not mean to make organisations static and rigid in their structures. It is about being adaptive, exploring and exploiting simultaneously. This requires organisational ambidexterity with a firm's ability to integrate internal and external knowledge in a process to create superior overall organisational performance in terms of high stakeholders' satisfaction, structures and processes combined with market power and dominate competition for technology, production, innovation, distribution resulting in profound customer loyalty.

Resilience refers to the capacity of an organisation to continuous reconstruction whilst responding to market changes as resilience is a fundamental quality to reply to disruptions through productivity without introducing an extended period of regressive behaviour. Resilience is about to carry out core activity and reply to disruptions without affecting social, technological or environmental processes attached to business. This shows resilience is an output achieved by combination of different activities by an organisation to sustain market forces. Strategy, structure, process and competitive strategy convey that being resilient is about either being defensive or offensive while responding to market forces arising from competitors' activities. This defensive or attacking responses to competitors could be made possible when organisation has any of the strategic assets' advantages such as lower costs, distinctive production, development and distribution capabilities, innovative products, reputation, network of relationships in the industry or superior operational processes or strong stakeholders' contribution.

A systems' perspective suggest that resilience could be achieved by diversity—multiple actions; efficiency—output with optimal resources consumption; adaptability—flexibility to change under new pressures; and cohesion—unifying relationships between system's variables and its elements. Applying a system's perspective, diversity and cohesion can be achieved with stakeholders' contribution and satisfaction leading to strong relationships with management; efficiency and adaptability can be achieved from sustaining the competitive advantage through internal processes and control over industry structure and market dynamics. Innovation and knowledge management could create organisational resilience. Confirming the aforementioned view organisational resilience can be achieved through organisational structures and committed and satisfied stakeholders such as employees and customers; increasing an organisation's competitiveness; from capacity—product innovativeness and competence orientation along with agility and behavioural preparedness; from corporate governance and stakeholders' contribution and from strategic capacity such as resources, employees, focused strategy and strategic actions such as creativity, flexibility, pro-activeness and decisional rapidity.

As evident from this discussion about resilience, it is proposed to measure resilience by applying sub-dimensions of competitiveness, growth of the company and the company's second set of stakeholders' contribution that is customers, suppliers, and debt holders (bond investors). Therefore, resilience is proposed as one of the over-arching variable to measure robustness of organisation from micro and macro forces and is included in this invention for measuring overall organisational performance.

FIG. 4 operationalises three sub-dimensions of Resilience which is comprised of competitiveness, growth and stakeholders' satisfaction.

Sustainability: Sustainability is defined here as the long-term survival, success and growth generated from appropriate utilisation of resources, capabilities and competitive advantage. This dimension is pertains to the longitudinal performance of the company. Stable and resilient organisation needs to sustain its two dimensional performance combination of stability and resilience, for a longer duration and to do that organisations should sustain its competitive position in the industry.

The competitive advantage of the firm could have been derived from within the firm or from the local or global environment so sustaining for a longer duration would require two efforts: internal managerial choices and changes in the strategy to respond to external market changes over the time and; to maintain the initial conditions of competitive advantage in the external environment. Therefore, sustainability is a performance outcome of a strategic input to increase the longevity of the competitive advantage of a firm. As discussed in previous sections of operationalising stability and resilience, actions and satisfaction of stakeholders (employees, suppliers, customers and investors) can immediately affect the organisational performance. However, the earlier view of strategic management considered stakeholders as legal and social constraints to limit the decision making and progress of an organisation.

The fundamental shift in management from this view to a new co-optation perspective and then to external stakeholders' participation in decision making has brought an influential concept of corporate social responsibility to fore. Simultaneously, community and government regulators as stakeholders expect the compliance, responsibility and governance from companies. Meeting these targets of compliance or social responsibility is ultimately considered as effectiveness test of top management and reputation test of the company as a whole. This poses another major trade off for managers and companies that how much duty businesses have towards society and what if being socially responsible can erode cash flows. At some point community and all other stakeholders' interests can supersede the interests of a firm's shareholders in the strategic decision making. Being socially responsible and having workable corporate social responsibility strategy allow organisations to create tangible benefits to businesses.

Hence, previously considered adversarial or non-traditional stakeholders are now given an equal or more importance than the owners or employees, to increase or to sustain the competitive advantage, to create or to maintain resources or intangible corporate reputation. Such a conceptual development suggests sustainability could be created with the help of durability, transparency, transferability, replicability and appropriateness of resources and capabilities only through human capital value addition from different groups of stakeholders of organisation.

Thus, sustainability can create competitive advantage or resources to last long and bring longevity to organisation. Therefore it is proposed in this invention to include all possible stakeholders' satisfaction in each major performance dimensions enhances the quality of overall organisational performance measurement. Corporate sustainability performance can be measured in terms of governance, transparency, accountability, social and environmental responsibility. Sustainability strategy is planned, implemented and monitored by top management and executive board which is accounted as an organisational effectiveness. Sustainability is implemented in operations through various governance mechanisms which is measured through performance of control mechanisms to operate appropriately.

Therefore, sustainability is proposed as one of the over-arching variables to assess the organisational capacity to attain longevity by measuring its effectiveness, governance and controls in this invention for measuring overall organisational performance.

FIG. 5 operationalises three sub-dimensions of Sustainability index which is comprised of organisational effectiveness, corporate governance and stakeholders' satisfaction.

Methodology: This section of methodology explains the generic procedure of applying this invention so that any person can understand the how this invention works. FIG. 1 explain the whole working of the system. FIG. 2 explains the concept of corporate credit ratings systems on the basis of overall organisational performance. FIG. 3, FIG. 4 and FIG. 5 each describes further detailed components to understand what to measure for overall organisational performance in terms of stability, resilience and sustainability. Data collection, scoring and benchmarking of values are performed for each sub-dimension to determine each final dimensional value. Each factor's weightings are determined further to generate a measurement of overall organisational performance. Thus, overall organisational performance for a company is determined.

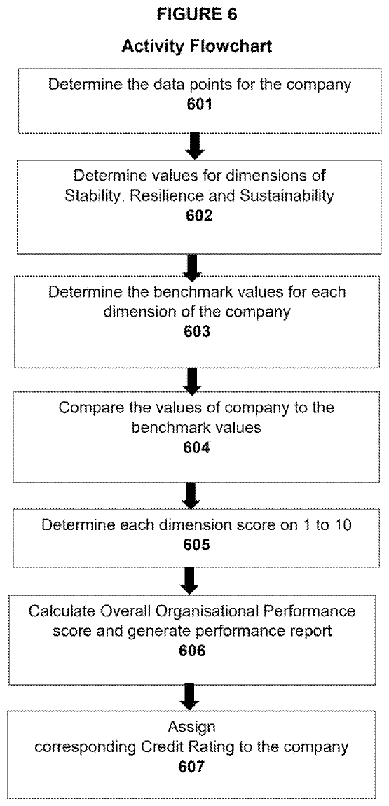

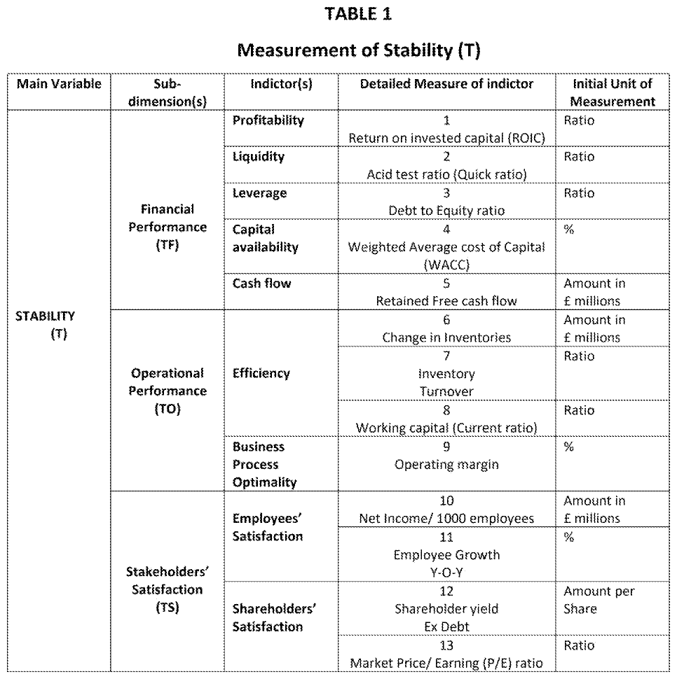

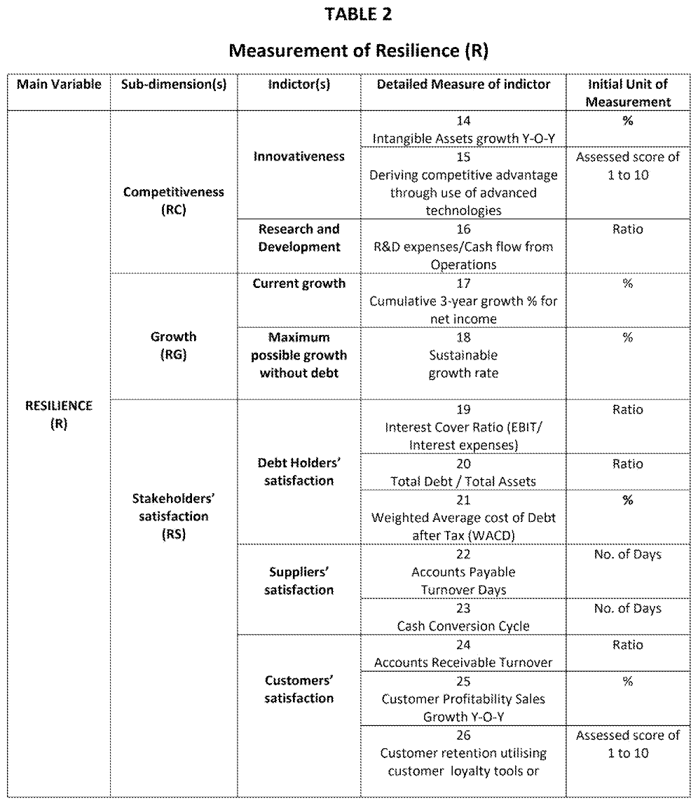

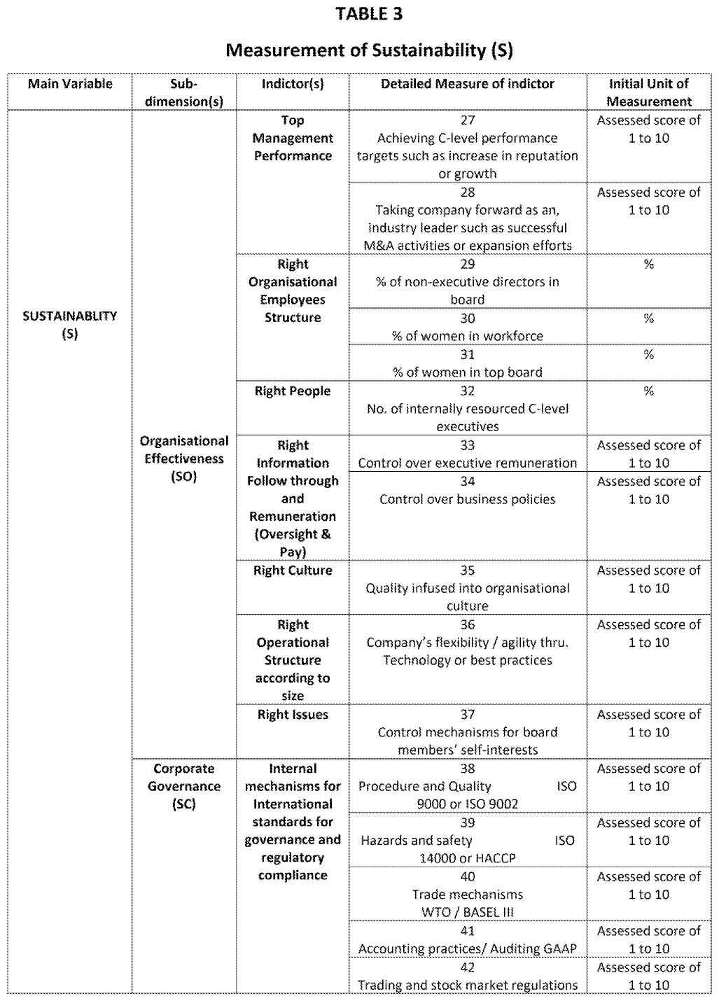

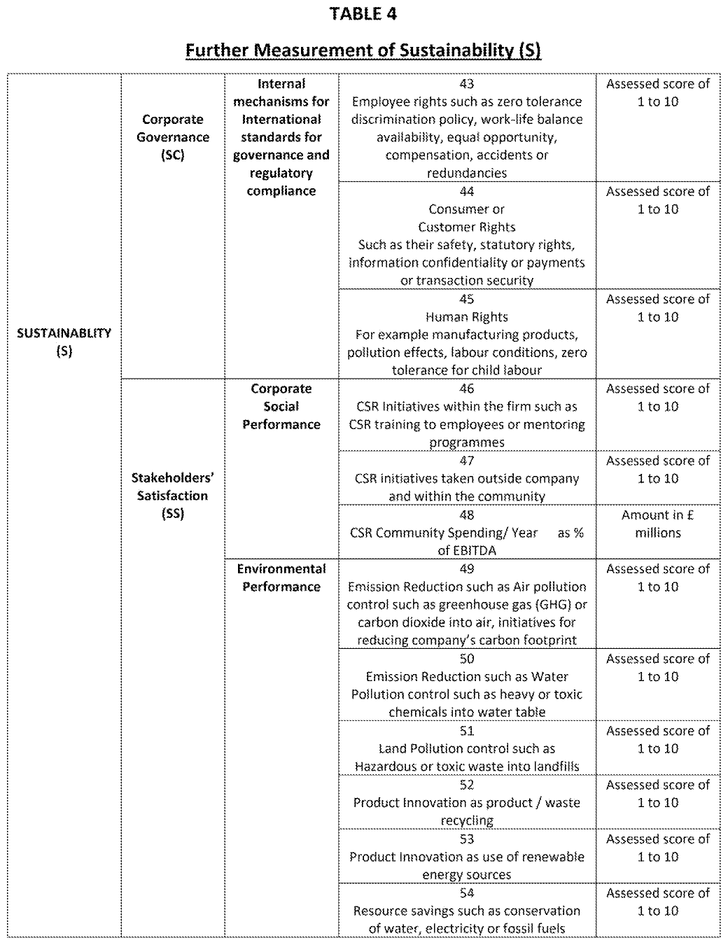

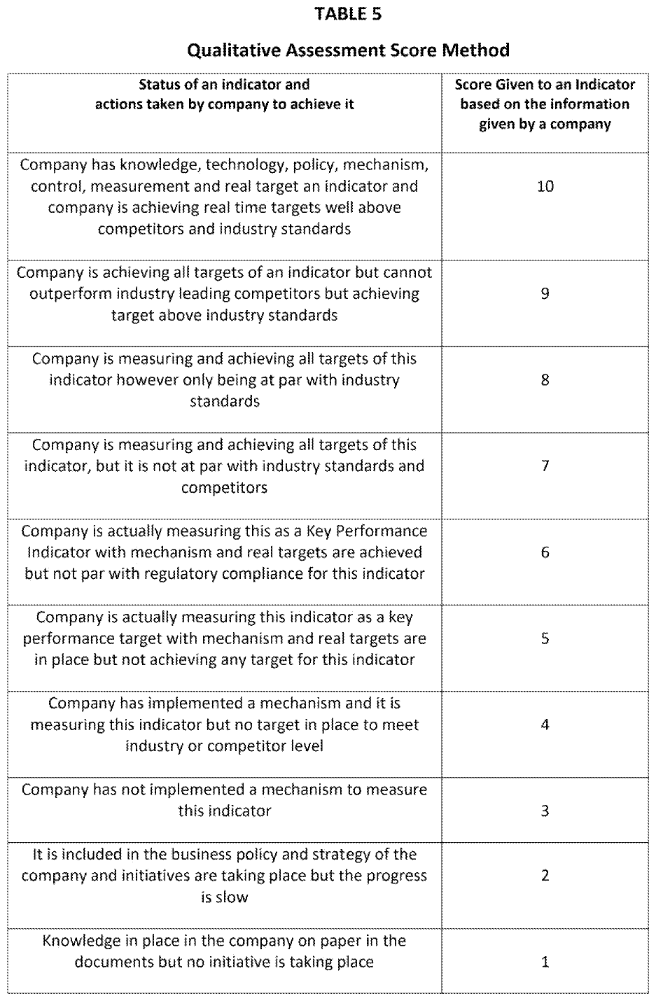

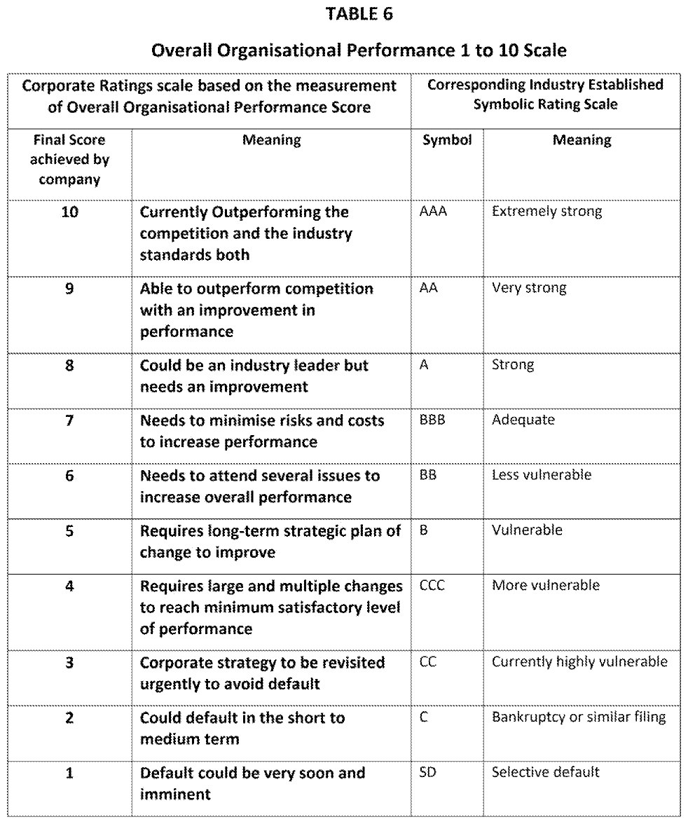

FIG. 6 explains the methodology of this invention in the form of logical sequence of activity flowchart in steps 601 to 607. The flowchart is a method for identifying the values for three variables stability, resilience and sustainability 602, benchmarking the values 603-604 and finalising factors and weights 605 to generate an overall organisational performance score and corresponding report 606 and credit ratings report 607. The method explained in the flowchart FIG. 6 works in the conjunction with detailed system explained in FIG. 1. Both method and system are explained as a way of example and not the limitation as there could be other methods applied to utilise the theoretical, novel, unique and contributing concept of corporate credit ratings to be assigned on the basis of overall organisational performance.

At step 601, data fields 1B are determined through data collection module 15 for the company 1A as shown in the system 10.

At step 602 these data fields are categorised and arranged for three indices of stability, resilience and sustainability. And they are assigned values. At step 603, values assigned to each sub-dimension is benchmarked for the industry of the company and are converted into comparable score on 1 to 10 scale. At step 604, benchmarking threshold values are compared to each sub-dimension value and thus index values are generated utilising benchmarking module 16 as mentioned in system 10. The benchmarking values could vary according to the industry the company operates in.

At step 605, factors are determined to be considered in each dimension's value and their weights are determined. At step 606, overall organisational performance score and report are generated based on final factors, weights and their values. These steps utilises the overall organisational performance module 13 in the system 10. Over-arching variables in FIG. 3, FIG. 4 and FIG. 5 have indicative sub-dimensions in level 2 and level 3 forming each variable. However, due to sudden changes in the market condition or due to any disruptive influences in the industry there could be addition or deletion of these sub-dimensions in data, and this is absorbed in the system 10. And, the data collection module 15 and data fields' module 1B shall be updated according to any such changes. System 10 as explained earlier could include a manual system of a hardware platform or a combination of systems or a system of machine readable instructions which can be ultimately utilised for executing all modules, steps, methodologies and functions explained here in the embodiments.

At step 606, overall organisational performance score and its report are generated. This overall organisational score between 1 to 10 can be mapped to a prevalent industry symbolic rating scale. A corresponding credit rating is reported in the module 12 leads to analysis of what should be the rating of the company. Hence, a final credit ratings is assigned to the company at step 607. This again utilises module 14 for generating credit ratings and module 12 for generating report.

Scores generated for overall organisational performance and credit ratings in steps 606 and 607 are compatible for a comparison and all are on the comparable scale of 1 to 10. This derived rating then can be forwarded to the ratings committee for the further evaluation and discussion before releasing and delivering a public rating to the company.

Theory of Invention: The main proposition of this invention to solve credit ratings issues. The solution proposed is a corporate credit rating can be derived based on the overall organisational performance as shown in FIG. 2. To make organisational performance and its attributes comparable and to carry out statistical analyses, a scale of 1 to 10 is prepared as shown in the Table 6 for overall organisational performance. This can be shown as following Equation (1).

A Corporate Credit Rating=f(Overall Organisational Performance) (1)

### Wherein, 1≤Overall Organisational Performance≤10

Then, as mentioned in FIG. 2, Overall Organisational Performance is further a combined function of Stability (T), Resilience (R) and Sustainability (S) as shown below in the Equation (2).

Overall Organisational Performance=f(Stability, Resilience, Sustainability) (2)

### Wherein,

1≤Stability≤10,
1≤Resilience≤10 and
1≤Sustainability≤10
   Further decoding of overall organisational performance leads to define the function of each major variable which comprises stability, resilience and sustainability as follows in Equation 3, 4 and 5 respectively.

Based on FIG. 3, Stability (T) is defined as a function, Stability of a corporate=f (Financial performance, Operational performance, Stakeholders satisfaction),

And its detailed measures are mentioned in Table 1.

Similarly, based on FIG. 4, Resilience (R) is defined as a function, Resilience of a corporate=f (Competitiveness, Growth, Stakeholders satisfaction And its detailed measures are mentioned in Table 2.

Similarly, based on FIG. 5, Sustainability (5) is defined as a function, Sustainability of a corporate=f (Organisational Effectiveness, Corporate Governance, Stakeholders satisfaction),

And its detailed measures are mentioned in Table 3 and Table 4.

A practical example: To derive a corporate rating, one must have data from a sample of companies sufficient enough to derive industry ranges so that when any corporate's data is available then it can be mapped and converted into 1 to 10 score for each detailed measure of indicator as mentioned in Table 1 to Table 4. Same sample of companies' data shall be converted into all scores of 1 to 10 as well for each indicator and then statistical analyses shall be carried out to find out weights or co-efficient for each sub-dimension for over-arching variable stability, resilience and sustainability. A scale from Table 5 is applied for measures which are subjective or qualitative in their assessment. This gives an equation for overall organisational performance and its over-arching variables. Any corporate belong to same industry can then have its overall organisational performance score derived on the 1to 10 scale once that corporate data is available. Overall score of organisational score can then be streamlined and converted into 1 to 10 range and mapped to corresponding symbolic scale of credit ratings prevalent in the industry as shown in the Table 6. Once compared then, a corporate can be assigned a credit rating based on the mapping. This will still be a provisional rating which then can be analysed, discussed and approved as a final credit rating by the ratings committee at any rating service provider.

Whilst all the embodiments are explained in detail with regard to overall system of corporate credit ratings on the basis of overall organisational performance, anyone skilled in the relevant domains can make any modification to any embodiment without the loss of generality, contributions, novelty and scope of this invention explained in the embodiments and claims are made as follows.

### CONCLUSION

The methodology of a credit rating based on the overall organisational performance and process of how to derive a credit rating applying that methodology are explained here regarding large corporates; however, this procedure can be followed to derive a credit rating even for micro, small or medium private enterprises whose less data may be available. Over-arching variables of Stability, Resilience and Sustainability and their sub-dimensions will remain same for any or all entities as a main feature of this invention; however, applying a logic of subjective significance any fundamental parameter can be added, removed, regrouped wherein a set of such parameters measures a sub-dimension for a particular over-arching variable without the loss of generality and validity of the invention.

1. A claim is made of method of deriving a credit rating, thereby to contribute in solving a set of conceptual and qualitative issues within the currently prevalent methods of corporate credit ratings, and the said issues can be categorised into four major problems to be addressed which are ‘what to measure’, ‘how to measure’, ‘how to analyse’ and ‘how to interpret’; and, the solution proposed here in this invention is to measure an overall organisational performance of a corporate which can be a listed and large company or any micro, small or medium enterprise; and further analyse and interpret the said overall organisational performance utilising a proprietary scale of 1 to 10 and then assign a corporate credit rating which corresponds to an industry standard of symbolic scale of credit ratings; and this method essentially consists of determining the said overall organisational performance by measuring Stability (T), Resilience (R) and Sustainability (S) of a corporate operating in the manufacturing and/or service industries wherein stability, resilience and sustainability further consists of dimensions and these dimensions comprise of individual measurable parameters.

2. A claim is made that the method of claim 1 of this invention in deriving a credit rating comprises of measuring the said overall organisational performance by measuring stability (T) through financial performance (TF), operational performance (TO) and stakeholders' satisfaction (TS); by measuring resilience (R) through competitiveness (RC), growth (RG) and stakeholders' satisfaction (RS); and by measuring Sustainability (S) through organisational effectiveness (SO), corporate governance (SC) and stakeholders' satisfaction (SS).

3. A claim is made that sub-dimensions mentioned in claim 2 for measuring a variable Stability (T) of any corporate comprises further measuring Financial Performance (TF) from profitability, liquidity, leverage, capital availability and cash flow; Operational Performance (TO) comprises of efficiency, business process optimality; and Stakeholders' Satisfaction (TS) comprises of employee's satisfaction and shareholder's satisfaction.

4. A claim is made that sub-dimensions mentioned in claim 2 for measuring a variable of Resilience (R) of any corporate comprises further measuring Competitiveness (RC) from innovativeness, research and development activities; Growth (RG) from current growth and maximum possible growth without debt; and, Stakeholders' Satisfaction (RS) from debt holders' satisfaction, suppliers' satisfaction and customers' satisfaction.

5. A claim is made that sub-dimensions mentioned in claim 2 for measuring a variable of Sustainability (S) of any corporate comprises further measuring Organisational Effectiveness (SO) from qualitative analyses of top management performance, organisational structure and people, information and remuneration oversight, culture, operational, structural and control mechanism issues; Corporate Governance (SC) from analyses of internal mechanisms for standards, governance and regulatory compliance;
and Stakeholders' Satisfaction (SS) comprises measuring corporate social performance and environmental performance.

6. A claim is made that as mentioned in the method of claim 3, sub-dimensions of Stability (T) comprise of financial performance (TF) which can be measured using profitability in terms of return of invested capital, liquidity in terms of quick ratio, leverage in terms of debt to equity ratio, capital availability in terms of weighted average cost of capital and cash flow in terms of retained free cash flow; comprise of operational performance (TO) which can be measured using efficiency in terms of change in the inventories, inventory turnover and current ratio for working capital analysis and business process optimality in terms of operating margin; comprise of stakeholders' satisfaction (TS) which can be measured using employees' satisfaction in terms of turnover per employee and year-over-year employee growth, and shareholders' satisfaction in terms of shareholders' yield (ex-debt) and price-earnings ratio.

7. A claim is made that as mentioned in the method of claim 4, sub-dimensions of Resilience (R) comprise of competitiveness (RC) which can be measured using innovativeness in terms of year-over-year intangible assets growth and competitive advantage of use of advanced technologies, and research and development (R&D) in terms of R&D expense ratio; comprise of growth (RG) which can be measured using current growth in terms of cumulative three years growth of net income and maximum possible growth without debt in terms of sustainable growth rate; and, comprise of stakeholders' satisfaction (RS) which can be measured using debt holders' satisfaction in terms of interest cover ratio, debt to asset ratio, weightage average cost of debt after tax (WACD), suppliers' satisfaction in terms of accounts payable turnover days and cash conversion cycle days, customers' satisfaction in terms of year-over-year sales growth and customer retention rate.

8. A claim is made that as mentioned in the method of claim 5, sub-dimensions of Sustainability (S) comprise of organisational effectiveness (SO) which can be measured using top management performance in terms of achieving C-level performance targets such as increase in reputation and taking company forward as an industry leader, organisational structure and people in terms of percentages of independent directors, inclusion of women in workforce and top management and number of internally resourced C-level executives, and information and remuneration oversight in terms of control over executive remuneration and business policies, culture in terms of quality infused into the organisation and operational, structural and control mechanism issues in terms of flexibility, agility and control of conflict of interests; comprise of corporate governance (SC) which can be measured using internal mechanisms for standards, governance and regulatory compliance in terms of adhering to quality and hazards and safety standards;
trade and capital mechanism or accounting practices as laid down by WTO/BASEL III and GAAP and trading or stock market regulations; and
comprise of stakeholders' satisfaction (SS) which can be measured using corporate social performance in terms of corporate social responsibility initiatives for employees, communities and percentage of community spending from Earnings before interest, tax, depreciation and amortization (EBITDA) and environmental performance in terms of reduction and control over air pollution, water pollution, land pollution, product or waste recycling, innovation and utilisation of renewable energy sources and resources savings such as conservation of water, electricity or fossil fuels.

9. A claim is made that method of claim 1 and claim 2 which comprises calculation and measures of Stability (T), Resilience (R) and Sustainability (S) requires that each known quantitative indicator measured as a unique number either as a ratio, percentage, amount or a common number is given a score on a scale of 1 to 10; and
similarly, each qualitative indicator is assessed from documents of a corporate and it is allocated a score on 1 to 10 from a proprietary scale is utilised as a ‘qualitative assessment score method’.

10. A claim is made that as proposed in claim 1, this invention provides a multi-modal and a distinctive solution to four major issues in corporate credit ratings; wherein a problem of ‘what to measure’—is solved by measuring an overall organisational performance for any corporate; and,
a problem of ‘how to measure’—is solved by considering an overall organisational performance as a higher order construct and measuring over-arching variables of Stability (T), Resilience (R) and Sustainability (S) using sub-dimensions and accurate and precise grouping and selection of their parameters and further indictors to measure the said parameters; and,
a problem of ‘how to analyse’—is solved by utilising correct scale for both quantitative and qualitative assessments of indicators including proprietary scale for ‘qualitative assessment score method’ and deploying a correct sequence of statistical analyses which enables reliable and valid output; and finally,
a problem of ‘how to interpret’—is solved by utilising a performance scale of 1 to 10 which is comparable and can be mapped to other prevalent scales in the credit ratings.

11. A claim is made that a multi-modal and distinctive solution of this invention, for corporate credit rating issues as detailed in both claim 1 and claim 10, has a better predictive accuracy of how a corporate is performing and during the process an overall organisational performance is measured by Stability (T), Resilience (R) and Sustainability (S) which represents a novel and valid higher order construct in the strategy and finance whilst contributing in these domains to advance them.
